(19) United States
(12) Patent Application Publication
(10) Pub. No.: US 2025/0316069 A1
(43) Pub. Date: Oct. 9, 2025

(54) Non-motor Vehicle Recognition Method and System Based on Multi-sensor Collaboration

(71) Applicant: Micronet Union Technology (Chengdu) Co., Ltd., Chengdu (CN)

(72) Inventors: Tao Chen, Chengdu (CN); Chunsheng Huang, Chengdu (CN); Mengya Liu, Chengdu (CN); Xinyun Guan, Chengdu (CN); Haitao Guan, Chengdu (CN); Qiang Xiong, Chengdu (CN); Weijie Huang, Chengdu (CN)

(21) Appl. No.: 18/932,546

(22) Filed: Oct. 30, 2024

(30) Foreign Application Priority Data
Apr. 9, 2024 (CN) 2024104173291

(51) Int. Cl. G06V 10/80; G06V 10/72; G06V 10/762; G06V 10/77; G06V 10/774; G06V 10/98; G06V 20/54

(52) U.S. Cl. CPC G06V 10/811; G06V 10/72; G06V 10/762; G06V 10/7715; G06V 10/774; G06V 10/806; G06V 10/993; G06V 20/54; G06V 2201/07; G06V 2201/08

(57) ABSTRACT

The present disclosure discloses a non-motor vehicle recognition method and system based on a multi-sensor collaboration and relates to the technical field of intelligent transportation. The method includes: constructing a sensor group based on a plurality of sensors, and performing a data collection based on a target range through the sensor group to generate a multi-class regional dataset; transmitting the multi-class regional dataset to a data fusion channel to generate an initial fusion dataset; synchronizing the initial fusion dataset to a data preprocessing unit to perform preprocessing to generate a target fusion dataset; utilizing a feature extraction unit to traverse the target fusion dataset to perform a feature extraction of a target non-motor vehicle, and generating a target feature information set; and constructing a target recognition unit, and intelligently recognizing the target fusion dataset through the target recognition unit.

### TECHNICAL FIELD

The present disclosure relates to the technical field of intelligent transportation, in particular to a non-motor vehicle recognition method and system based on a multi-sensor collaboration.

### BACKGROUND

An existing non-motor vehicle recognition method and system, although utilizing complementary advantages of various sensors to improve accuracy and stability of recognition, still has many shortcomings. Data processing becomes complex due to the redundancy and conflict of data between different sensors. At the same time, high cost, high complexity, and poor environmental adaptability limit its wide application. Therefore, optimizing sensor configurations, improving data processing efficiency, and reducing costs are still urgent problems to be solved by this technology.

### SUMMARY

The present application provides a non-motor vehicle recognition method and system based on a multi-sensor collaboration, which are used to be targeted at solving a technical problem that data processing is complex due to the redundancy and conflict of data between different sensors in the prior art.

In view of the above problem, the present application provides a non-motor vehicle recognition method and system based on a multi-sensor collaboration.

A first aspect of the present application provides a non-motor vehicle recognition method based on a multi-sensor collaboration, including:
constructing a sensor group based on a plurality of sensors, and performing a data collection based on a target range through the sensor group to generate a multi-class regional dataset; transmitting the multi-class regional dataset to a data fusion channel to generate an initial fusion dataset; synchronizing the initial fusion dataset to a data preprocessing unit to perform preprocessing, and updating the initial fusion dataset to generate a target fusion dataset; traversing the target fusion dataset to perform a feature extraction of a target non-motor vehicle utilizing a feature extraction unit, and generating a target feature information set, wherein there is a correspondence between the target feature information set and the target fusion dataset; and constructing a target recognition unit based on the target feature information set, and intelligently recognizing the target fusion dataset through the target recognition unit.

A second aspect of the present application provides a non-motor vehicle recognition system based on a multi-sensor collaboration, including:
a multi-class regional dataset generating module, constructing a sensor group based on a plurality of sensors, and performing a data collection based on a target range through the sensor group to generate a multi-class regional dataset; an initial fusion dataset generating module, transmitting the multi-class regional dataset to a data fusion channel to generate an initial fusion dataset; a target fusion dataset generating module, synchronizing the initial fusion dataset to a data preprocessing unit to perform preprocessing, and updating the initial fusion dataset to generate a target fusion dataset; a target feature information set generating module, utilizing a feature extraction unit to traverse the target fusion dataset to perform a feature extraction of a target non-motor vehicle, and generating a target feature information set, wherein there is a correspondence between the target feature information set and the target fusion dataset; and an intelligent recognition module, constructing a target recognition unit based on the target feature information set, and intelligently recognizing the target fusion dataset through the target recognition unit.

One or more technical solutions provided in the present application at least have the following technical effects or advantages.

The present application constructs a sensor group based on a plurality of sensors, and performs a data collection based on a target range through the sensor group to generate a multi-class regional dataset; transmits the multi-class regional dataset to a data fusion channel to generate an initial fusion dataset; synchronizes the initial fusion dataset to a data preprocessing unit to perform preprocessing, and updates the initial fusion dataset to generate a target fusion dataset; utilizes a feature extraction unit to traverse the target fusion dataset to perform a feature extraction of a target non-motor vehicle, and generates a target feature information set; and constructs a target recognition unit based on the target feature information set, and intelligently recognizes the target fusion dataset through the target recognition unit. The present disclosure solves the technical problem that data processing is complex due to the redundancy and conflict of data between different sensors in the prior art, and achieves a technical effect of improving accuracy and stability of recognition precision by fusing data from different sensors.

### BRIEF DESCRIPTION OF DRAWINGS

In order to explain technical solutions in embodiments of the present disclosure more clearly, accompanying drawings that need to be used in descriptions of the embodiments will be briefly introduced below. Apparently, the accompanying drawings in the following descriptions are some embodiments of the present disclosure, and for those of ordinary skill in the art, on the premise of no creative work, other accompanying drawings may further be obtained from these accompanying drawings.

FIG. 1 is a schematic flowchart of a non-motor vehicle recognition method based on a multi-sensor collaboration provided by an embodiment of the present application.

FIG. 2 is a schematic structural diagram of a non-motor vehicle recognition system based on a multi-sensor collaboration provided by an embodiment of the present application.

Description of reference numerals: multi-class regional dataset generating module 11, initial fusion dataset generating module 12, target fusion dataset generating module 13, target feature information set generating module 14, and intelligent recognition module 15.

### DETAILED DESCRIPTION

The present application provides a non-motor vehicle recognition method and system based on a multi-sensor collaboration, which are used to be targeted at solving a technical problem that data processing is complex due to the redundancy and conflict of data between different sensors in the prior art, and achieving a technical effect of improving accuracy and stability of recognition precision by fusing data from different sensors.

Technical solutions in embodiments of the present application will be clearly and completely described below in conjunction with accompanying drawings in the embodiments of the present application. Apparently, the described embodiments are only a part of the embodiments of the present application, not all of the embodiments. Based on the embodiments in the present application, all other embodiments obtained by those of ordinary skill in the art without making creative work belong to the protection scope of the present application.

It needs to be noted that terms “first”, “second” and the like in the specification and claims of the present application and the above accompanying drawings are used to distinguish similar objects, and need not be used to describe a specific order or sequence. It should be understood that data so used may be interchanged in appropriate cases so that the embodiments of the present application described here can be implemented in an order other than those illustrated or described here. In addition, terms “include” and “have”, as well as any variations thereof are intended to cover non-exclusive incorporations, e.g., a process, method, system, product, or server that incorporates a series of steps or units need not be limited to those steps or units clearly listed, but may include other steps or modules that are not clearly listed or are inherent to this process, method, product, or device.

### Embodiment 1

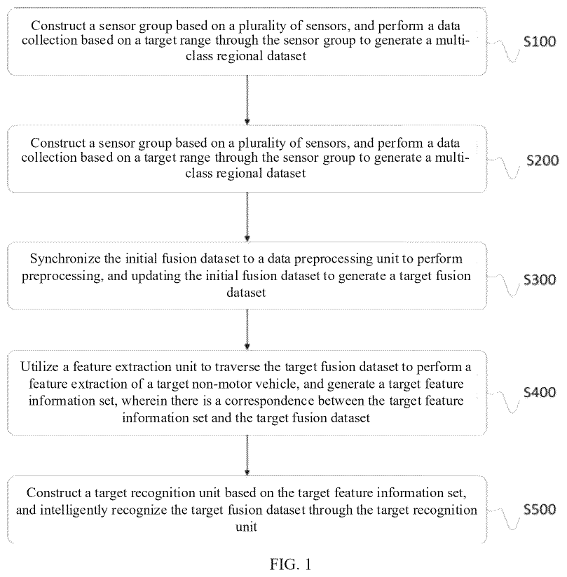

As shown in FIG. 1, the present application provides a non-motor vehicle recognition method based on a multi-sensor collaboration, including:
step S100: a sensor group is constructed based on a plurality of sensors, and a data collection is performed based on a target range through the sensor group to generate a multi-class regional dataset.

In the embodiment of the present application, suitable sensors are selected according to actual application demands and environmental characteristics. These sensors include, but are not limited to, cameras, radar, infrared sensors, speed sensors, position sensors, etc., each of which has different sensing capabilities and characteristics, and monitors and obtains different types of data.

Next, these sensors are deployed within the target range. Deployment positions are selected by considering factors such as a region where a target non-motor vehicle may appear, a communication distance between the sensors, and coverage. After a deployment is completed, a unique identifier is assigned to each sensor, and communication protocols and connection modes between them are established. Through a communication association, the sensor group forms a unified network to realize sharing of data and collaborative work.

After the sensor group has been constructed and the communication association has been established, data collection work starts. The sensor group collects various data in real time within the target range according to a preset sampling frequency and parameter settings. These data include information such as a trajectory, speed, position and direction of the non-motor vehicle, as well as data related to a surrounding environment, such as weather conditions and a light intensity.

The collected data are classified and regionalized to generate the multi-class regional dataset. When classification and regionalization are performed, the collected data are preprocessed and analyzed by clustering. The data are classified according to sources and types of the data, e.g., image data collected by the cameras, speed data obtained by the radar, etc. are classified respectively. The classified data are then processed using a clustering algorithm, such as k-means, which divides the data according to spatial positions or feature similarities to form a plurality of regional datasets. Eventually, the classified and regionalized data are integrated into the multi-class regional dataset.

Step S200: the multi-class regional dataset is transmitted to a data fusion channel to generate an initial fusion dataset.

In the embodiment of the present application, a format of the multi-class regional dataset is unified, and these data are converted to a unified format by data preprocessing. Next, the multi-class regional dataset is transmitted to the data fusion channel. Real-time and synchronization of the data are ensured during transmission. By using the same hardware to issue trigger collection commands at the same time, time synchronization of the collection and measurement of each sensor is realized, so that the data from different sensors can be consistent in time or space through a unified time stamp or space calibration.

An appropriate data fusion strategy is developed in the data fusion channel. The data fusion strategy is determined based on the types of data, importance, and a fusion target. For example, for some key data, a weighted average mode is adopted for fusion; while for some auxiliary data, only operations such as simple accumulation or taking a maximum are performed.

Fusion processing is performed on the multi-class regional dataset according to the developed fusion strategy. Fusion processing includes data layer fusion, feature layer fusion and decision layer fusion. The data layer fusion directly fuses original data to generate a new dataset; the feature layer fusion fuses extracted features to form a richer representation of the features; and the decision layer fusion makes a comprehensive judgment after each sensor makes a preliminary decision. After the above fusion processing, the initial fusion dataset is generated.

Step S300: the initial fusion dataset is synchronized to a data preprocessing unit to perform preprocessing, and the initial fusion dataset is updated to generate a target fusion dataset.

In the embodiment of the present application, the initial fusion dataset is synchronized to the data preprocessing unit to perform preprocessing. Data cleaning is performed first in a preprocessing process to eliminate noises, abnormal values and redundant information from the data. For the initial fusion dataset, there are the noises and abnormal values introduced due to sensor errors, transmission interference, and other reasons. These bad data are recognized and removed through data cleaning to improve purity and accuracy of the data. Subsequent and retrograde data standardization and normalization convert the data in the initial fusion dataset into the same dimension and range. Feature extraction and selection are then performed to convert the original data into more representative feature vectors, highlighting intrinsic laws and patterns of the data. Finally, data enhancement and transformation are performed to increase the amount and diversity of the data.

After the above preprocessing steps, the initial fusion dataset is updated to generate the target fusion dataset.

Step S400: a feature extraction unit is utilized to traverse the target fusion dataset to perform a feature extraction of the target non-motor vehicle, and a target feature information set is generated, wherein there is a correspondence between the target feature information set and the target fusion dataset.

In the embodiment of the present application, first it is ensured that the feature extraction unit is configured correctly, an appropriate feature extraction algorithm is selected, for example, a SIFT algorithm is used to adjust parameters according to specific demands of recognition of the non-motor vehicle, and feature information useful for the recognition of the non-motor vehicle is extracted.

Next, the feature extraction unit starts traversing the target fusion dataset. Each record or each data point in the dataset is accessed sequentially in a certain order, e.g., row by row or column by column, and in a traversing process, the feature extraction unit analyzes attributes and features of each data point. According to a preset feature selection criterion, features useful for the recognition of the non-motor vehicle are selected from each data point, and these features include shape, size, etc., reflecting uniqueness of the non-motor vehicle and its difference from other objects.

After the feature selection and extraction, the feature extraction unit will generate one target feature information set. This set contains all the feature information extracted from the target fusion dataset and has a one-to-one correspondence with the target fusion dataset.

Step S500: a target recognition unit is constructed based on the target feature information set, and the target fusion dataset is intelligently recognized through the target recognition unit.

In the embodiment of the present application, a convolutional neural network model is selected to construct the target recognition unit. The convolutional model is trained by collecting datasets containing a large number of non-motor vehicle images obtained from actual shooting and labeling. These datasets contain the non-motor vehicle images in various scenarios, angles and lighting conditions to ensure that the model can learn enough feature information.

The datasets containing the large number of non-motor vehicle images are fed as input data into the convolutional neural network, and the convolutional neural network converts the original images into high-level feature representations by extracting image features layer by layer. After processing through a plurality of convolutional layers, pooling layers, and fully connected layers, the network outputs a probability distribution indicating a probability that the input images belong to each non-motor class. In order to improve a recognition performance of the model, the model is optimized by adjusting a network structure and optimizing hyperparameter settings, and a regularization technology is adopted to prevent overfitting.

The construction of the target recognition unit is completed through the above process to realize the intelligent recognition of a non-motor vehicle target.

Further, step S100 in the method provided by the embodiment of the application further includes:
deploying the plurality of sensors within the target range based on monitoring demand information, communicatively associating the sensors within the same region, and constructing the sensor group according to association information;
performing the data collection on the target region through the sensor group to generate a plurality of regional datasets; and
performing a cluster analysis on the plurality of regional datasets to generate the multi-class regional dataset.

In the embodiment of the present application, the type of data to be collected is determined according to the monitoring demand information of the non-motor vehicle, including traffic, speed, driving trajectory, parking position, etc. of the non-motor vehicle. Based on this information, a suitable type of sensor, such as a video sensor, radar sensor, infrared sensor, etc., is selected for targeted deployment within the target range. After the deployment is completed, sensors in the same region are communicatively associated through a wireless communication technology, such as ZigBee.

After the sensor group is constructed, the data collection starts for the target region. Images, speeds, positions and other information of the non-motor vehicle are captured in real time by the sensors to generate the plurality of regional datasets. Each regional dataset contains detailed data of the non-motor vehicles in the region, such as traffic statistics, a speed distribution, and a driving trajectory map.

Next, the cluster analysis is performed on the plurality of regional datasets to recognize features and behavioral patterns of the non-motor vehicles in different regions. For example, the K-Means algorithm is used to divide the target region into a high traffic region, a low traffic region, a fast driving region, a slow driving region, etc. according to the traffic and speed data of the non-motor vehicle to generate the multi-class regional dataset.

Further, step S200 in the method provided by the embodiment of the present application further includes:
performing time stamp normalization on the multi-class regional dataset, detecting a time deviation of the multi-class regional dataset based on a standard time stamp, and generating time deviation data;
performing a time calibration based on the time deviation data, verifying a time alignment degree according to a calibration result, and establishing a fusion time alignment branch;
constructing a virtual space coordinate system, traversing the multi-class regional dataset to perform a positional registration, and generating a registration coordinate set;
verifying a space alignment degree based on the registration coordinate set, and establishing a fusion space alignment branch; and
constructing the data fusion channel based on the fusion time alignment branch and the fusion space alignment branch, wherein there exists a sequence of connections between the fusion time alignment branch and the fusion space alignment branch.

In the embodiment of the present application, time stamp standardization is performed due to differences in the format and precision of the time stamps of various datasets due to the variety of data sources and different collection devices. When the time stamp standardization is performed, a unified time stamp format is first determined, e.g., based on a format of an international standard, such as ISO8601. The time stamps of all the datasets are then converted to this unified format to ensure consistency in their presentation. Finally, according to analysis demands, the precision of the time stamps needs to be unified, e.g., all the time stamps are accurate to a second or minute level.

After the time stamp normalization is completed, a time deviation between the multi-class regional datasets is detected based on these standard time stamps. The time deviation is caused by various factors during data collection, transmission or processing. When the time deviation between the multi-class regional datasets is detected, the time stamps from different datasets representing same or similar moments are paired. Pairing is realized by comparing the proximity of the time stamps, a time window is set, and the time stamps within this window are considered as paired time stamps. Then, a time difference between these paired timestamps is calculated to obtain a time interval between them. Next, these time differences are analyzed statistically, such as calculating a mean, standard deviation, etc., to understand a distribution and extent of the time deviation. Finally, those time deviation values that are obviously abnormal are recognized to obtain time deviation data.

The time calibration is then performed using the time deviation data to adjust the time stamps of the datasets so that they are aligned onto a unified timeline. The time calibration is performed by methods such as interpolation, resampling, or time shifting, and the calibrated datasets have a consistent time reference. After the time calibration, the time alignment degree is verified by comparing a difference in the time stamps before and after the calibration, calculating an alignment error, and other modes. The fusion time alignment branch is established based on the above steps.

After the time alignment is completed, a space registration is performed. First, the virtual space coordinate system is constructed. The coordinate system is two or three dimensional, depending on space characteristics of the dataset. Then, the multi-class regional datasets are traversed to perform the positional registration, and the spatial position information in different datasets is aligned into the unified virtual space coordinate system through coordinate conversion, coordinate transformation, spatial interpolation and other methods to generate the registration coordinate set.

Then based on the registration coordinate set, spatial offsets between them are calculated by calculating an Euclidean distance between coordinates, a Manhattan distance, or other appropriate measurement modes to compare the registration coordinate set between the different datasets. The calculated spatial offsets are statistically analyzed, and a distribution and extent of the offsets are understood by calculating statistics such as a mean, maximum, minimum, and standard deviation of the offsets. An appropriate space alignment degree threshold is set according to analysis demands and data characteristics. The calculated spatial offsets are compared with the set threshold to assess an alignment degree of the multi-class regional dataset in a spatial dimension. If the offset is less than or equal to the threshold, the space alignment degree is considered to meet the requirements. Otherwise, a space registration method or parameters are readjusted.

After the verification of the space alignment degree is completed, the fusion space alignment branch is established to realize the automated alignment and fusion of the multi-class regional datasets in the spatial dimension. When the fusion space alignment branch is established, a framework of the fusion space alignment branch is constructed according to a process of space registration and verification. Selected space registration algorithms, such as algorithms for realizing a feature extraction, registration transformation calculation, coordinate mapping, etc., are integrated into the fusion space alignment branch, then the multi-class regional datasets are automatically read through a scripting language, such as Python, afterwards features of the multi-class regional datasets are extracted for space registration, finally the space alignment degree is verified, an alignment result is outputted, and an automated process for the fusion space alignment branch is realized. During a branch operation, parameters and algorithms of the space registration are continuously optimized according to the verification result of the space alignment degree so as to improve the alignment precision and efficiency. The fusion space alignment branch is established through the above process.

The data fusion channel is constructed based on the fusion time alignment branch and the fusion space alignment branch. In this channel, there exists the sequence of connections between the fusion time alignment branch and the fusion space alignment branch. For example, time alignment is performed first, followed by space alignment. The data are first time-calibrated through the fusion time alignment branch to ensure the consistency of a temporal dimension. The time-aligned data are then passed to the fusion space alignment branch for the spatial registration to ensure the consistency of the spatial dimension. After processing by these two branches, the data will have unified time and space references, providing a basis for a subsequent data fusion and analysis.

An order of time and space alignment is not fixed and is adjusted according to specific application scenarios and data characteristics.

Further, the method further includes:
transmitting the multi-class regional dataset to the fusion time alignment branch to generate time alignment information of the multi-class regional dataset;
transmitting the multi-class regional dataset to the fusion space alignment branch to generate space alignment information of the multi-class regional dataset;
developing a data fusion strategy based on the time alignment information and the space alignment information;
configuring weights for the multi-class regional datasets in combination with the data fusion strategy to obtain distributed weight sets, wherein the distributed weight sets and the multi-class regional datasets are in one-to-one correspondence, and a sum of the distributed weight sets is equal to 1; and
performing a preliminary fusion of data on the multi-class regional datasets in accordance with the data fusion strategy based on the distributed weight sets to generate the initial fusion dataset.

In the embodiment of the present application, the multi-class regional datasets to be processed are transmitted to the established fusion time alignment branch. In the fusion time alignment branch, the datasets undergo steps such as time stamp normalization, time deviation detection, and time calibration to ensure that temporal dimensions of different datasets are aligned to a unified timeline. After time alignment processing, the branch generates time alignment information. Time alignment information includes a calibrated time stamp, time alignment error statistics, a time alignment degree evaluation results, etc.

The multi-class regional datasets are transmitted to the fusion space alignment branch, and in the fusion space alignment branch, the datasets undergo steps such as feature extraction, space registration, and space alignment degree verification to ensure that the spatial positions of the different datasets can correspond to each other accurately. After space alignment processing, the branch generates space alignment information. The space alignment information includes a registered coordinate set, spatial offset statistics, a space alignment degree evaluation result, etc.

The data fusion strategy is developed according to Bayesian estimation. A prior distribution is defined for parameters of each data source according to historical data, or other reliable information. Based on the time alignment information and space alignment information, a likelihood function corresponding to each data source is calculated. A posterior distribution of the parameters is calculated using Bayes' theorem in combination with the prior distribution and the likelihood function. For a plurality of data sources, their corresponding posterior distributions are fused by weighted average and product fusion. A fusion result is extracted from a fused posterior distributions.

Before starting a weight configuration, the multi-class regional datasets are first preprocessed. Principles of weight configuration are determined according to the data fusion strategy. These principles are determined based on the reliability, correlation, importance, quality and other factors of the data. For example, higher weights are assigned to datasets with higher time and space alignment degrees, and lower weights are assigned to datasets with more noise or abnormal values. According to the principles of weight configuration, the weight of each dataset is calculated by variance analysis, correlation analysis and other methods. After the above steps, a distributed weight set is generated. Each weight in this set corresponds to a specific multi-class regional dataset, and a sum of these weights is equal to 1.

When the preliminary fusion of data is performed, a weighted average is performed on values of each dataset according to the distributed weight set. Specifically, for each data point or feature, its value is multiplied with the weight of the corresponding dataset, and then all the weighted values are summed to obtain a fused value. After the fusion calculation in the above steps, the initial fusion dataset is obtained.

Further, step S300 in the method provided by the embodiment of the present application further includes:
performing data cleaning on the initial fusion dataset, and executing multiple data processing instructions according to a cleaning result, wherein the multiple data processing instructions include missing value processing and abnormal value processing;
generating a cleaned dataset through the missing value processing and the abnormal value processing; and
integrating the cleaned dataset, performing a data reduction on the integrated cleaned dataset, verifying the cleaned dataset based on a reduction result, and updating the initial fusion dataset as the target fusion dataset for an output.

In the embodiment of the present application, data cleaning is first performed on the initial fusion dataset to correct errors and inconsistencies in the initial fusion dataset and to improve a data quality. Afterwards, the multiple data processing instructions are executed according to the cleaning result. For missing values in the dataset, a mean, median, mode, or specific value is used to fill in. For abnormal values in the dataset, a statistical method, such as Z-score, is used to recognize them, and depending on actual situations, a selection is made to remove the abnormal values, or to replace the abnormal values with a mean or a median. The cleaned dataset is obtained after the missing value processing and the abnormal value processing.

When the cleaned dataset is integrated, data formats are first unified to ensure that all datasets are consistent in terms of field names, data types, and data formats. When conflicting data are processed, i.e., when different datasets conflict on the same field, a value from one data source is retained by voting or weighting. Finally, during a merging process, duplicate data are removed to ensure that the integrated dataset does not contain redundant information.

When the data reduction is performed, based on the importance and correlation of the data, features that are most meaningful to a subsequent analysis are selected, and features that do not have a significant impact on an analysis result are removed. A high dimensional feature space is converted to a low dimensional feature space by dimensionality reduction technologies such as a principal component analysis and a linear discriminant analysis. When the dataset is too large, a part of representative data is selected through sampling technologies, such as random sampling and stratified sampling, to reduce the complexity of data processing and analysis.

Afterwards, the cleaned dataset is verified based on the reduction result, and data integrity is checked to ensure that no important information or features are missing from the reduced dataset. A statistical method is then used to compare the datasets before and after the reduction to assess the impact of a reduction process on a data analysis result. Finally, according to actual demands, whether the reduced dataset can still meet analysis requirements is checked. After the verification of the above steps, if it is confirmed that the quality and accuracy of the cleaned dataset after the reduction meets the requirements, then it is updated as the initial fusion dataset and output as the target fusion dataset.

Further, the method further includes:
obtaining a target analysis result, a background analysis result, and a noise point analysis result according to the target fusion dataset;
inputting the target analysis result, background analysis result and noise point analysis result into a judger, and obtaining a recognition correction analysis result according to the judger, wherein the recognition correction analysis result includes the target analysis result, and/or the background analysis result and/or the noise point analysis result; and
generating, with the recognition correction analysis result, a monitoring tag to identify an abnormal point position in the target fusion dataset based on the monitoring tag.

In the embodiment of the present application, the feature extraction is first performed on the target fusion dataset, from which features related to the non-motor vehicle are extracted, and these features include a shape, size, speed, motion trajectory, etc. of the non-motor vehicle. Afterwards, the extracted features are classified and recognized to filter out the data matching with the non-motor vehicle. Classified and recognized results are integrated to form the target analysis result. The result includes information such as a position, number, and motion state of the non-motor vehicle.

The background analysis result refers to other environmental information that is not relevant to the target. Features related to the environment, such as road conditions, buildings, vegetation, etc., are extracted from the target fusion dataset. The extracted environmental features are integrated to form the background analysis result.

The noise point analysis result is an analysis of abnormal or wrong data in the target fusion dataset. These noise points are caused by a sensor failure, a data transmission error, etc. A statistical method is utilized to detect abnormal values or wrong data in the target fusion dataset. The detected abnormal values are classified and recognized to determine if they are noise points and to analyze reasons for their generation. Results of noise point classification and recognition are integrated to form the noise point analysis result.

The target analysis result, the background analysis result and the noise point analysis result are input into the judger, and the judger performs a comprehensive analysis and judgment on these results according to a preset rule to obtain the recognition correction analysis result. In this process, the judger corrects the target analysis result according to the background analysis result, or removes wrong data according to the noise point analysis result. The finally obtained recognition correction analysis result includes a corrected target analysis result, the background analysis result, and/or data after noise point removal.

Generating the monitoring tag begins with parsing the recognition correction analysis results to clarify a type, position, speed, trajectory, and other key data of the non-motor vehicle contained therein. Based on the parsed recognition correction analysis result, the corresponding monitoring tag is generated. The monitoring tag is an abstract representation of a state of the non-motor vehicle that reflects a real-time state of the non-motor vehicle. For example, a tag is generated for each non-motor vehicle containing information such as its unique identification, position, speed, and state.

With the monitoring tag, abnormal point positions in the target fusion dataset are identified based on the monitoring tag. The abnormal point positions are data points that do not conform to a normal operating state of the non-motor vehicle. They are caused by a sensor failure, a data transmission error, or other reasons. When the abnormal point positions are identified, a judgment is made according to information in the monitoring tag in combination with the preset rules. For example, a speed threshold is set, when a speed of the non-motor vehicle exceeds this threshold, it is considered to be in an abnormal state, and a corresponding data point is identified as an abnormal point position.

Further, the method further includes:
performing training according to a training operator to obtain the judger, wherein the training operator includes a plurality of groups of training samples, wherein each group of training samples includes a preset target sample, a preset background sample, a preset noise point sample, and a test sample; and
obtaining a discrimination error precision according to the judger, and analyzing the target fusion dataset by activating the judger when the discrimination error precision is less than a preset error precision.

In the embodiment of the present application, the training operator includes a plurality of groups of training samples, wherein each group of training samples includes a preset target sample, a preset background sample, a preset noise point sample, and a test sample. The preset target sample is a non-motor vehicle recognized and extracted in the target fusion dataset. The preset background sample represents target-independent background information in the target fusion dataset. The preset noise sample simulates that the target fusion dataset contains possible abnormal or wrong data, including noise data due to a sensor failure, a data transmission error, etc. The test sample is used to evaluate a performance of the judger during training.

Before starting the training, an appropriate model structure is selected, in the present application, the convolutional neural network model is selected, and the model is trained iteratively using the samples from the training operator. In each iteration, a group of samples is randomly selected from the training operator, and fed into the model, and a difference between an output of the model and an actual tag, i.e., a loss function, is calculated. An optimization algorithm, such as gradient descent, is then used to update parameters of the model to minimize the loss function. This process is repeated several times until the performance of the model reaches a preset requirement or a preset number of iterations is reached. After the training is completed, the judger is obtained.

Next the judger is applied to a group of independent verification sample sets to obtain the discrimination error precision. The verification sample sets should contain data with known tags, and the discrimination error precision refers to a ratio of the number of samples correctly classified by the judger to a total number of samples. When the discrimination error precision is less than a preset error precision threshold, the performance of the judger is considered to reach the requirement, and it may be activated to analyze the target fusion dataset.

After the discrimination error precision of the judger meets the requirement, the judger is activated to analyze the target fusion dataset.

In the embodiment of the present application, in summary, the embodiment of the present application at least has the following technical effects:

The present application constructs a sensor group based on a plurality of sensors, and performs a data collection based on a target range through the sensor group to generate a multi-class regional dataset; transmitting the multi-class regional dataset to a data fusion channel to generate an initial fusion dataset; synchronizes the initial fusion dataset to a data preprocessing unit to perform preprocessing, and updates the initial fusion dataset to generate a target fusion dataset; utilizing a feature extraction unit to traverse the target fusion dataset to perform a feature extraction of a target non-motor vehicle, and generating a target feature information set; and constructs a target recognition unit based on the target feature information set, and intelligently recognizes the target fusion dataset through the target recognition unit. The present disclosure solves the technical problem that data processing is complex due to the redundancy and conflict of data between different sensors in the prior art, and achieves a technical effect of improving accuracy and stability of recognition precision by fusing data from different sensors.

### Embodiment 2

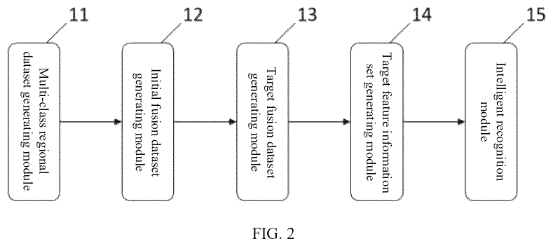

Based on the same inventive concept as the non-motor vehicle recognition method based on a multi-sensor collaboration in the preceding embodiment, as shown in FIG. 2, the present application provides a non-motor vehicle recognition system based on a multi-sensor collaboration, and the system in the embodiment of the present application is based on the same inventive concept as the method embodiment. The system includes:
a multi-class area dataset generating module 11, constructing a sensor group based on a plurality of sensors, and performing a data collection based on a target range through the sensor group to generate a multi-class area dataset;
an initial fusion dataset generating module 12, transmitting the multi-class area dataset to a data fusion channel to generate an initial fusion dataset;
a target fusion dataset generating module 13, synchronizing the initial fusion dataset to a data preprocessing unit to perform preprocessing, and updating the initial fusion dataset to generate a target fusion dataset;
a target feature information set generating module 14, utilizing a feature extraction unit to traverse the target fusion dataset to perform a feature extraction of a target non-motor vehicle, and generating a target feature information set, wherein there is a correspondence between the target feature information set and the target fusion dataset; and
an intelligent recognition module 15, constructing a target recognition unit based on the target feature information set, and intelligently recognizing the target fusion dataset through the target recognition unit.

Further, the system further includes:
deploying the plurality of sensors within the target range based on monitoring demand information, communicatively associating the sensors within the same region, and constructing the sensor group according to association information;
performing the data collection on the target region through the sensor group to generate a plurality of regional datasets; and
performing a cluster analysis on the plurality of regional datasets to generate the multi-class regional dataset.

Further, the system further includes:
performing time stamp normalization on the multi-class regional dataset, detecting a time deviation of the multi-class regional dataset based on a standard time stamp, and generating time deviation data;
performing a time calibration based on the time deviation data, verifying a time alignment degree according to a calibration result, and establishing a fusion time alignment branch;
constructing a virtual space coordinate system, traversing the multi-class regional dataset to perform a positional registration, and generating a registration coordinate set;
verifying a space alignment degree based on the registration coordinate set, and establishing a fusion space alignment branch; and
constructing the data fusion channel based on the fusion time alignment branch and the fusion space alignment branch, wherein there exists a sequence of connections between the fusion time alignment branch and the fusion space alignment branch.

Further, the system further includes:
transmitting the multi-class regional dataset to the fusion time alignment branch to generate time alignment information of the multi-class regional dataset;
transmitting the multi-class regional dataset to the fusion space alignment branch to generate space alignment information of the multi-class regional dataset;
developing a data fusion strategy based on the time alignment information and the space alignment information;
configuring weights for the multi-class regional datasets in combination with the data fusion strategy to obtain distributed weight sets, wherein the distributed weight sets and the multi-class regional datasets are in one-to-one correspondence, and a sum of the distributed weight sets is equal to 1; and
performing a preliminary fusion of data on the multi-class regional datasets in accordance with the data fusion strategy based on the distributed weight sets to generate the initial fusion dataset.

Further, the system further includes:
performing data cleaning on the initial fusion dataset, and executing multiple data processing instructions according to a cleaning result, wherein the multiple data processing instructions include missing value processing and abnormal value processing;
generating a cleaned dataset through the missing value processing and the abnormal value processing; and
integrating the cleaned dataset, performing a data reduction on the integrated cleaned dataset, verifying the cleaned dataset based on a reduction result, and updating the initial fusion dataset as the target fusion dataset for an output.

Further, the system further includes:
obtaining a target analysis result, a background analysis result, and a noise point analysis result according to the target fusion dataset;
inputting the target analysis result, background analysis result and noise point analysis result into a judger, and obtaining a recognition correction analysis result according to the judger, wherein the recognition correction analysis result includes the target analysis result, and/or the background analysis result and/or the noise point analysis result; and
generating, with the recognition correction analysis result, a monitoring tag to identify an abnormal point position in the target fusion dataset based on the monitoring tag.

Further, the system further includes:
performing training according to a training operator to obtain the judger, wherein the training operator includes a plurality of groups of training samples, wherein each group of training samples includes a preset target sample, a preset background sample, a preset noise point sample, and a test sample; and
obtaining a discrimination error precision according to the judger, and analyzing the target fusion dataset by activating the judger when the discrimination error precision is less than a preset error precision.

It needs to be noted that the above sequence of the embodiment of the present application is for a descriptive purpose only and does not represent advantages or disadvantages of the embodiment. Moreover, specific embodiments of the present specification are described above. Other embodiments are within the scope of the appended claims. In some cases, actions or steps recorded in the claims may be executed in an order different from that in the embodiments and still realize desired results. Further, the processes depicted in the accompanying drawings do not necessarily require the specific order or successive order shown to realize the desired results. In some implementations, multitasking and parallel processing may be possible or may be advantageous.

The above is only better embodiments of the present application and is not used to limiting the present application, and any modification, equivalent replacement, improvement, etc. made within the spirit and principle of the present application should be included in the scope of protection of the present application.

This specification and the accompanying drawings are only exemplary illustrations of the present application and are considered to have covered any and all modifications, variations, combinations, or equivalents within the scope of the present application. Apparently, those of skill in the art can make various modifications and variations to the present application without departing from the scope of the present application. In this way, if these modifications and variations of the present application are within the scope of the present application and its technical equivalents, the present application is intended to include such modifications and variations.

What is claimed is:

1. A non-motor vehicle recognition method based on a multi-sensor collaboration, comprising:
constructing a sensor group based on a plurality of sensors, and performing a data collection based on a target range through the sensor group to generate a multi-class regional dataset;
transmitting the multi-class regional dataset to a data fusion channel to generate an initial fusion dataset;
synchronizing the initial fusion dataset to a data preprocessing unit to perform preprocessing, and updating the initial fusion dataset to generate a target fusion dataset;
utilizing a feature extraction unit to traverse the target fusion dataset to perform a feature extraction of a target non-motor vehicle, and generating a target feature information set, wherein there is a correspondence between the target feature information set and the target fusion dataset; and
constructing a target recognition unit based on the target feature information set, and intelligently recognizing the target fusion dataset through the target recognition unit.

2. The method according to claim 1, wherein constructing a sensor group based on a plurality of sensors, and performing a data collection based on a target range through the sensor group to generate a multi-class regional dataset comprises:
deploying the plurality of sensors within the target range based on monitoring demand information, communicatively associating the sensors within the same region, and constructing the sensor group according to association information;
performing the data collection on the target region through the sensor group to generate a plurality of regional datasets; and
performing a cluster analysis on the plurality of regional datasets to generate the multi-class regional dataset.

3. The method according to claim 1, wherein the method for the data fusion channel comprises:
performing time stamp normalization on the multi-class regional dataset, detecting a time deviation of the multi-class regional dataset based on a standard time stamp, and generating time deviation data;
performing a time calibration based on the time deviation data, verifying a time alignment degree according to a calibration result, and establishing a fusion time alignment branch;
constructing a virtual space coordinate system, traversing the multi-class regional dataset to perform a positional registration, and generating a registration coordinate set;
verifying a space alignment degree based on the registration coordinate set, and establishing a fusion space alignment branch; and
constructing the data fusion channel based on the fusion time alignment branch and the fusion space alignment branch, wherein there exists a sequence of connections between the fusion time alignment branch and the fusion space alignment branch.

4. The method according to claim 3, wherein transmitting the multi-class regional dataset to a data fusion channel to generate an initial fusion dataset comprises:
transmitting the multi-class regional dataset to the fusion time alignment branch to generate time alignment information of the multi-class regional dataset;
transmitting the multi-class regional dataset to the fusion space alignment branch to generate space alignment information of the multi-class regional dataset;
developing a data fusion strategy based on the time alignment information and the space alignment information;
configuring weights for the multi-class regional datasets in combination with the data fusion strategy to obtain distributed weight sets, wherein the distributed weight sets and the multi-class regional datasets are in one-to-one correspondence, and a sum of the distributed weight sets is equal to 1; and
performing a preliminary fusion of data on the multi-class regional datasets in accordance with the data fusion strategy based on the distributed weight sets to generate the initial fusion dataset.

5. The method according to claim 1, wherein synchronizing the initial fusion dataset to a data preprocessing unit to perform preprocessing, and updating the initial fusion dataset to generate a target fusion dataset comprises:
performing data cleaning on the initial fusion dataset, and executing multiple data processing instructions according to a cleaning result, wherein the multiple data processing instructions include missing value processing and abnormal value processing;
generating a cleaned dataset through the missing value processing and the abnormal value processing; and
integrating the cleaned dataset, performing a data reduction on the integrated cleaned dataset, verifying the cleaned dataset based on a reduction result, and updating the initial fusion dataset as the target fusion dataset for an output.

6. The method according to claim 1, comprising:
obtaining a target analysis result, a background analysis result, and a noise point analysis result according to the target fusion dataset;
inputting the target analysis result, background analysis result and noise point analysis result into a judger, and obtaining a recognition correction analysis result according to the judger, wherein the recognition correction analysis result includes the target analysis result, and/or the background analysis result and/or the noise point analysis result; and
generating, with the recognition correction analysis result, a monitoring tag to identify an abnormal point position in the target fusion dataset based on the monitoring tag.

7. The method according to claim 6, comprising:
performing training according to a training operator to obtain the judger, wherein the training operator includes a plurality of groups of training samples, wherein each group of training samples includes a preset target sample, a preset background sample, a preset noise point sample, and a test sample; and
obtaining a discrimination error precision according to the judger, and analyzing the target fusion dataset by activating the judger when the discrimination error precision is less than a preset error precision.

8. A non-motor vehicle recognition system based on a multi-sensor collaboration, comprising:
a multi-class regional dataset generating module, constructing a sensor group based on a plurality of sensors, and performing a data collection based on a target range through the sensor group to generate a multi-class regional dataset;
an initial fusion dataset generating module, transmitting the multi-class regional dataset to a data fusion channel to generate an initial fusion dataset;
a target fusion dataset generating module, synchronizing the initial fusion dataset to a data preprocessing unit to perform preprocessing, and updating the initial fusion dataset to generate a target fusion dataset;
a target feature information set generating module, utilizing a feature extraction unit to traverse the target fusion dataset to perform a feature extraction of a target non-motor vehicle, and generating a target feature information set, wherein there is a correspondence between the target feature information set and the target fusion dataset; and
an intelligent recognition module, constructing a target recognition unit based on the target feature information set, and intelligently recognizing the target fusion dataset through the target recognition unit.
